(19) United States
(12) Patent Application Publication
(10) Pub. No.: US 2015/0172310 A1
(43) Pub. Date: Jun. 18, 2015

(54) METHOD AND SYSTEM TO IDENTIFY KEY LOGGING ACTIVITIES

(71) Applicant: Infosys Limited, Bangalore (IN)

(72) Inventors: Ashutosh Saxena, Hyderabad (IN); Harigopal K.B. Ponnapalli, Hyderabad (IN); Krishna Chaitanya Telikicherla, Hyderabad (IN)

(73) Assignee: Infosys Limited, Bangalore (IN)

(21) Appl. No.: 14/493,648

(22) Filed: Sep. 23, 2014

(30) Foreign Application Priority Data
Dec. 17, 2013 (IN) 5877/CHE/2013

(51) Int. Cl. H04L 29/06; H04L 29/08; G06F 21/57

(52) U.S. Cl. CPC H04L 63/1441; G06F 21/577; H04L 67/10; G06F 2221/033

(57) ABSTRACT

A method and a system to identify key logging activities is described. The method comprises triggering of at least one cloud computing network by opening of at least one browser of one or more digital device, generating of at least one proof by the cloud computing network and sending the generated proof to the sanitizer, triggering of the sanitizer by opening of the browser of the digital device to generate one or more random sequence of keystrokes, generating at least one malicious list by the sanitizer by capturing the system processes that capture the randomly generated keystrokes, updating the cloud computing network by the sanitizer with the generated malicious list, retrieving of proof by each of the system processes, verifying of the fetched proof of the system process by the proof checker and updating the cloud computing network with the restricted system processes by the proof checker.

### FIELD

The field relates to a method and a system to identify key logging activities. Particularly, the field relates to a method which alerts the user of any keylogging activities happening in the system. More particularly a method of detecting if a keylogger installed in the system sends information across the internet.

### BACKGROUND

Keyloggers are the software's or hardware's that record all the keystrokes. These keystrokes are stored mostly in a file or memory block on the host computer and can be accessed at later point. Most keyloggers send that file to the hacker's computer at some later point of time. The latest keyloggers only send certain important information instead of sending the entire set of keystrokes of the user. Hackers are typically more interested in retrieving confidential information like credit card details or passwords.

Most keyloggers will make an entry to the registry of the operating system (OS) during the time of installation and then start when the operating system boots from the system. When the user presses a key on the keyboard, the keyboard driver receives the scan code corresponding to the key being pressed. There will be a unique scan code corresponding to all the keys on the keyboard. This scan code will be sent to the keyboard device driver, which translates it to a virtual-key code, which is a device independent value defined by the system that identifies the purpose of the key.

The keyboard driver then creates a message that includes the scan code, the virtual key and other keystroke information and then places the message in the system message queue. The message is then removed from the system message queue and is sent to the corresponding thread of the application. The thread's message loop removes the message and passes it to the appropriate window procedure of the application for processing.

The keylogger intercepts the keystrokes either at the keyboard driver level by replacing the keyboard driver with the malicious keylogger driver or by adding filters between the keyboard driver and the system message queue or by hooking the various operating system application programming interface (API) calls. Hooking happens when the keystroke message arrives in the message queue and the callback function associated with the keyloggers is called to record the keystroke. This message is then stored to a file which is transferred to the hacker via E-mail, file transfer protocol (FTP) or internet relay chat (IRC) channel.

Keylogging is one such action of tracking or logging the keys struck on a keyboard, typically in a covert manner so that the person using the keyboard is unaware that their actions are being monitored. There are mainly two types of keyloggers—hardware based keyloggers and software based keyloggers. Various proposals have been made to detect and prevent keylogging activities in the system. Most of the anti-viruses use signature based schemes to identify these keyloggers or spyware, but such an approach is ineffective against zero day keyloggers.

Various behavioral based detection systems have also been proposed which identify the behavior of key logging activities. Some other technology involves preventing the keylogging activities include encrypting the keystrokes before it enters the system and the decryption only happens when it reaches the application. This ensures that the keylogger gets only the encrypted content and cannot decrypt it unless it has the key. But still these techniques will be ineffective against the form grabbers.

In today's era of Digital World, the consumer of digital services and utilities is attacked in multiple ways. Keylogging is one such action of tracking (or logging) the keys struck on a keyboard, typically in a covert manner so that the person using the keyboard is unaware that their actions are being monitored. These programs which accomplish the task of key logging are called keyloggers.

The keyloggers can attack the system at various levels. There exist vulnerability at the kernel and the application level. In the application level, the keyloggers can hook the various events and record the keystrokes. This type of keylogger is easier to implement and to detect. The user activity can also be recorded at the kernel level by replacing the software driver with the malicious keylogging drivers. These are difficult to implement as well as to combat.

There are various technologies that exist to combat keyloggers. One among them is signature based detection schemes of antivirus. They identifies the signature which are the various characteristics of a keylogger such as file size, file name, a checksum or registry entries and then detects it. But these will be ineffective against the zero day keyloggers and unknown keyloggers.

Some other preventive measures have been taken to combat these which include virtual keyboards. But there are aggressive keyloggers that could grab the screenshots on every mouse clicks which determines the user entered key. Similarly various form grabbers who grab the details entered in the form and sends these details to the hacker to a remote computer are also present. Form grabbing is done by exploiting the vulnerabilities in the web browsers.

There are various other proposals made which identifies the behavior of the keyloggers and alert the user for its presence. But these can lead to high false rates and hence become ineffective.

“Bait your hook” by Stefano Ortolani has proposed an idea which helps to detect the presence of keyloggers in the system. The proposal suggests generating a specific sequence which will be recorded by the keylogger and find for those processes which has recorded the keylogging events.

Some other technology involves preventing the keylogging activities include encrypting the keystrokes before it enters the system and the decryption only happens when it reaches the application. This ensures that the keylogger gets only the encrypted content and cannot decrypt it unless it has the key. But still these techniques will be ineffective against the form grabbers.

Form Grabbing is an advanced way of capturing web based data and this is usually done by exploiting the vulnerability of the web browsers. This software will intercept the web form data and store the credentials for further use.

Keyloggers are not malicious software but this property of keyloggers to store keystrokes is used for stealing the confidential data by the hackers. These confidential data is sent to the remote computer of the hacker.

Most modern keyloggers are considered to be legitimate software or hardware sold on open market. Keylogger developers claim that they can be useful when it comes to parental control, company tracking the employees and also for law enforcement. But most of the times they are used to steal confidential information by the hackers.

The hackers were able to steal millions of dollars with the help of this software. There should be a mechanism by which we need prevent the stealing of confidential data.

Conventional strategies have enjoyed various levels of success to detect the presence of keyloggers by identifying the signature or behavior of the keyloggers. But still they can be bypassed by various aggressive keyloggers.

Thus there is a need to provide detection of these keyloggers. An advisory system is developed which alerts the user if there is any keylogging activity happening in the system. The alert happens when the keylogger tries to send the information with keystrokes across the network to some remote machine or store it in local machine for later usage. The present invention or disclosure is a virtual guard available as cloud based service on demand which does this job, once requested, of alerting the user of possible malicious keystroke activities. This service can be called or requested from the user's computer or any mobile gadget or device and it advices the user if any keystroke logging happens in the system. This cloud based service can become available for multiple form factors or devices.

### SUMMARY

According to one of the aspect of the present disclosure there is provided a method that comprises steps of triggering of at least one cloud computing network by opening of at least one browser of one or more digital devices. The browser is embedded with a plugin, wherein the plugin comprising at least one sanitizer and at least one proof checker.

Further generating of at least one proof by the cloud computing network and sending the generated proof to the sanitizer and triggering of the sanitizer by opening of the browser of the digital device to generate one or more random sequence of keystrokes. Further generating at least one malicious list by the sanitizer by capturing the system processes that capture the randomly generated keystrokes and the system processes that perform at least one malicious operation;

Then updating the cloud computing network by the sanitizer with the generated malicious list. Retrieving of proof by each of the system processes, wherein the system processes show at least one of their identities or at least one of their attributes to the sanitizer to fetch their corresponding proofs from the sanitizer.

The verifying of the fetched proof of the system process by the proof checker and allowing the system processes with valid proof and restricting the rest of the system processes and updating the cloud computing network with the restricted system processes by the proof checker where the restricted system processes are stored into the malicious list.

According to another aspect of the present disclosure there is provided a system that comprises at least one browser of one or more digital device embedded with a plugin, wherein the plugin comprising at least one sanitizer and at least one proof checker.

The sanitizer operatively connected with the cloud computing network to receive at least one malicious list and at least one proof from the cloud computing network; wherein the sanitizer generates random key strokes and captures at least one of the system processes that capture such generated key strokes, wherein the sanitizer creates one malicious list by capturing the system processes that capture the randomly generated keystrokes and the system processes that perform at least one malicious operations and the cloud computing network is updated with the malicious list by the sanitizer.

The sanitizer receives at least one proof for each system processes, the system processes show at least one of their identities or at least one of their attributes to the sanitizer to fetch its corresponding proof from the sanitize.

The proof checker operatively connected with the sanitizer to verify the fetched proof of the system process and allowing the system processes with valid proof and restricting the rest of the system processes.

It is identified that the keylogger is dangerous since it could be installed remotely. Mostly stealing of information happens by sending confidential data across the internet to the hacker's system. The present invention aims at detecting if a keylogger installed in the system sends information across the internet.

The present technologies can have a systematic well defined approach of handling key logging actions and also provide a feasible technical implementation with well-defined sets of protocol. The technology can be a service based architecture which tells the user about the activity of keylogging in a system. This will give the user to use any computing device from anywhere in the internet or cloud and create a unique secure experience everywhere.

### BRIEF DESCRIPTION OF THE ACCOMPANYING DRAWINGS

These are further features of the present disclosure are better understood by reading the following detailed description of the drawing, wherein,

FIG. 1 illustrates an exemplary browser system with the sanitizer and the proof checker.

FIG. 2 illustrates the activity of the sanitizer.

FIG. 3 illustrates activity of the proof checker with the sanitizer.

FIG. 4 illustrates work flow of the sanitizer.

FIG. 5 illustrates work flow of the proof checker.

FIG. 6 illustrates an exemplary blacklisting process by taking an interaction of malicious operations.

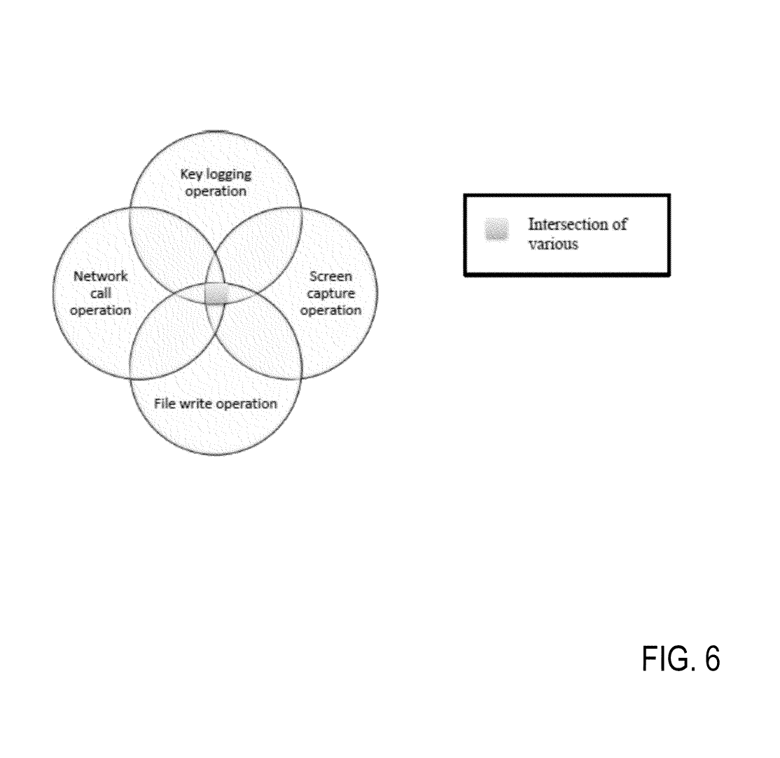

FIG. 7 illustrates an exemplary browser alerting the presence of form grabber.

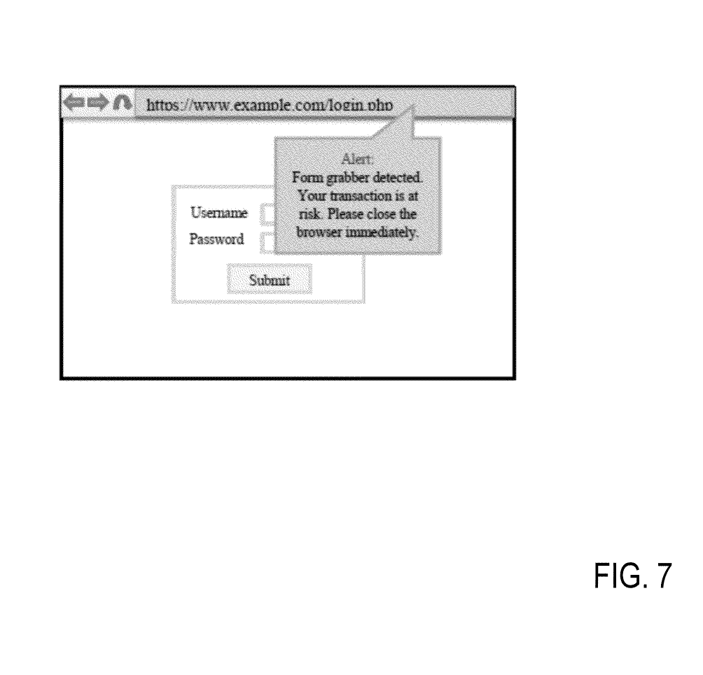

### DETAILED DESCRIPTION

The present disclosure relates to detection of keyloggers. A system is developed which alerts the user if there is any keylogging activity happening in the system. The alert happens when the keylogger tries to send the information with keystrokes across the network to some remote machine or store it in local machine for later usage.

This allows the user to walk to any host computer whether it is a computer in a computer café or any business computer and this service alerts the user if any keylogging activity happens in the system. The present service does an authentication of the user for the server before and after any key logging activities starts on the local machine of the user.

The detection system is a virtual guard available as cloud based service or could computing network on demand alerting the user of possible malicious keystroke activities. A modified browser, containing two new components proposed by us (sanitizer and proof checker), works in tandem with the service. This cloud service can be called or requested from the user's computer or any mobile gadget or device having our modified browser and it advices the user if any keystroke logging happens in the system.

Further by way of example and not limitation our invention can be deployed or used in multiple form factors like mobile phones, tablet PC etc.

The utility of the method is achieving high rate detection by advising the user of the host about the data which is being sent from the host computer. The method makes sure that any data which is being sent from the host computer is sent with user's knowledge. The user has to give approval for the packet or data or information to be sent across. This method therefore prevents the hackers to get access to the confidential data even if he successfully installs the keylogger in the remote machine. The cloud service after identifying the keylogging activity informs the user about the application which does this activity.

The invention is a virtual guard available as cloud based service on demand which does this job, once requested, of alerting the user of possible malicious keystroke activities. A modified browser, containing two new components proposed by us (sanitizer and proof checker), works in tandem with the service. This service can be called or requested from the user's computer or any mobile gadget/device having our modified browser and it advices the user if any keystroke logging happens in the system.

By way of example and not limitation, the present disclosure discloses about a defense-in-depth solution which is based on verification of proof when a network I/O or file I/O operation is done. Further our invention can be deployed or used in multiple forms of digital devices.

The system detects for keyloggers by using a software as a service offered on the cloud server which is less subjected to fall in the evil hands and corruption. The prevention of corruption of the system is ensured by providing a mutual authentication between the service on the host and the server which offer and imposes the updates on the service. This methodology ensures that the service gets its updates from a trusted server and not from any malicious server. Any malicious server attempting to update the service will not be able to corrupt the host service system since it can fail authentication.

Further the software as a service for detecting the keystrokes in the user system and further advices the user if the logged keystrokes is being exported to any other remote computer through the internet.

The present disclosure makes use of software as a service concept which advices the user about the keylogging activity in the system under use. The services are hosted in the cloud and being offered to the host computer where the user is allowed to perform their activities securely.

In case of other form factors like mobile phones the communication between the mobile phone and Computer happens with wireless connectivity.

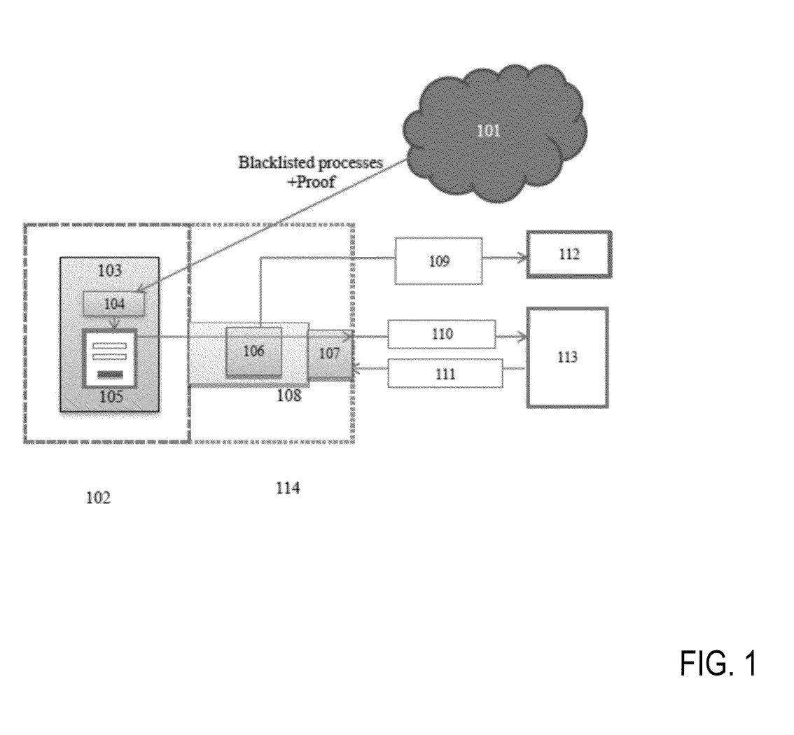

FIG. 1 shows the browser subsystems which are involved in a typical HTTP transaction, the components the sanitizer 104 and the proof checker 108, are introduced is the present disclosure. The different components of the system are explained below by way of example and not limitation.

The evil server 112 controlled by an attacker (an evil entity). It collects data from several vulnerable hosts and misuses it, thereby causing loss to end users.

Genuine server 113 controlled by genuine web administrators and accepts/serves content without any malicious intent.

HTTP request 110 and HTTP Response 111 for any interaction on the web which involves communication between browser and server take place via the HTTP protocol. A HTTP client 102 (e.g., browser) sends data to a server via a HTTP Request 110 and it gets data form the server via a HTTP Response 111.

Network stack 114 is when a HTTP request 110 is triggered by a user's action in a browser 102, it passes through a component of the operating system called network stack 114 and reaches the destination server. It is in this component that encryption of content happens.

Evil HTTP POST 109 is a web request sent by a malicious entity (e.g., form grabber) to a malicious (Evil) server 112. A HTTP request 110 can be sent via two methods—GET and POST. Typically, attackers use POST method as it allows sending large data across websites.

Encryption module 107 is where on an “https” enabled webpage, once data is submitted, it reaches the encryption module, EM. This module helps in encrypting web traffic before sending it to the web server. If any third party attempts to sniff the data after it passes out of EM, it will only receive encrypted data and hence cannot extract original content.

Form Grabber 106 (FG a malicious software which installs itself in the web traffic pipeline, before the encryption module. Since it receives unencrypted data, it will be able to send it to attacker's website, thereby stealing user's content.

Form grabbers 106 intercept form data even before the HTTP request reaches the encryption module (EM) and exfiltrate the data to evil servers. Even if the sanitization step fails, the sanitizer and the proof checker prevent this exfiltration of data.

By way of example and not limitation, every network I/O, file I/O operation done by any process goes through a proof checking phase.

Through mechanisms similar to key exchange protocols, the proof received from the cloud service 101 is shared by the sanitizer 104 with legitimate processes.

The browser 102 of a digital device is embedded with a plugin. The plugin have the sanitizer 104 and the proof checker 108.

By way of example and not limitation the proof-checker 108 will verify the proof and based on the outcome of the check, it will inform and/or allow and/or block network I/O, file I/O operations. By way of example and not limitation malware such as form grabbers, key loggers will not be able to submit valid proofs and hence the proof checking phase will not pass. Thus, their operations will be blocked and end users will be alerted about the malicious attempt on the host system.

Sanitizer 104 advices the user if any keylogging activities are taking place in the system by analyzing the packets. It acts as a virtual remote service for the keylogger, consuming the data returned by our cloud based service and triggering sanitization actions. When the sanitizer gets invoked in the host computer, it generates a random sequence of keystrokes, awaits for the keyloggers to record the keys and creates a filtered list of suspicious processes.

The sanitizer 104 and proof checker 108, into state-of-the-art web browsers 102, which work in tandem with the cloud based services 101 also known as the cloud computing network 101.

The sanitizer 104, with the assistance of the cloud based service 101, advices the user if any keylogging activities are taking place in the system by analyzing the packets. The analysis of the packet is carried out by the sanitizer 104 and lets the user know that a particular packet is being sent from the host computer to a typical destination. The sanitizer will make sure that the user is aware of the packet which is leaving the system. If the user is unaware of it, then the sanitizer 104 checks the application which sends the packet from the host computer. The sanitizer 104 initially analyzes the behavior of the applications that runs on the host computer.

The cloud based service 101 consists a kernel for the execution of the application (the Sanitizer), on the client side, that analyses the network packets before it leaves the host computer. The browser components 102, sanitizer 104 and proof checker 108, work in tandem with the cloud service. The sanitizer acts as a virtual remote service for the keylogger, consuming the data returned by our cloud based service and triggering sanitization actions.

By way of example and not limitation, when the sanitizer gets invoked in the host computer, it generates a sequence of keystrokes which is randomly generated. This generation of the keys is for the keyloggers to record the keys. The sanitizer lists all the processes running in the system and checks if these processes perform a hooking operation. A filtered list is created which consist of processes that perform hooking operation.

The sanitizer then analyses those processes which performs a write operation on the file or on the memory. Another list called write list is created that contains those processes which performs the write operation. The process which performs screenshots will also be monitored during this process. During this process no packets are allowed to leave the system.

A new list of processes which does both the hooking and the write operation is listed. This list is called the suspicious list. Among the processes in the suspicious list, the sanitizer checks for those processes which are common among the suspicious list and the list of processes which performs screen shots. These processes would be marked severe and the rest of the processes would be marked normal in the suspicious list. (This entire process is what we call sanitization and hence the name sanitizer).

The sanitizer advices the user about the suspicious programs which does keylogging activity and hence kills those programs according to users wish.

To prevent masquerade and to prevent the compromise of session keys, essential identification and session key information must be communicated in encrypted form. The mutual authentication protocol enables the server in cloud hosting the services and the service running to satisfy themselves mutually about each other's identity to exchange the session keys. After the key exchange happens, and both the services at the host and the server in the cloud established a session, the updates can be downloaded to the host.

This way, the sanitizer acts as first line of defense against keyloggers residing in the host machine.

Apart from the sanitization methodology, we also propose an additional layer of protection, which acts as a defense-in-depth solution. When the user authenticates with the cloud service before starting normal browsing session, the service also sends a unique proof (which could be as simple as a random number) to the sanitizer. Whenever a network call or file-write operation is made by any process/subsystem, it has to prove that it has the necessary permission to do so.

The sanitizer operatively connected with the cloud computing network to receive a malicious list or the black list and a proof from the cloud computing network.

The sanitizer generates random key strokes and captures the system processes that capture such generated key strokes.

Further the sanitizer creates one malicious list by capturing the system processes that capture the randomly generated keystrokes and the system processes that perform at least one malicious operations and the cloud computing network is updated with the malicious list by the sanitizer. The sanitizer receives at least one proof for each system processes, the system processes show at least one of their identities or at least one of their attributes to the sanitizer to fetch its corresponding proof from the sanitizer.

The proof checker operatively connected with the sanitizer to verify the fetched proof of the system process and allowing the system processes with valid proof and restricting the rest of the system processes.

The cloud computing network is triggered when the browser is opened. Further cloud computing network comprises at least one proof. The proof comprises at least one random number. the cloud computing network generates at least one proof when the system process performs at least one malicious operations.

By way of example and not limitation, the system processes that perform malicious operations comprises combination of one or more key logging operations or network call operations or screen capture operations or file write operation.

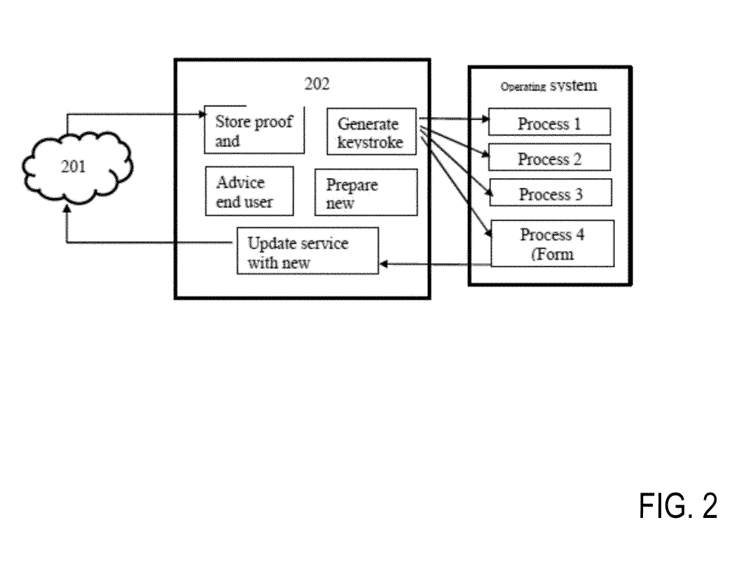

FIG. 2 discloses the activity of sanitizer in detail.

As soon as a user opens a browser, the sanitizer 202 gets invoked and it contacts the cloud service 201. The cloud service 201 sends an existing blacklist of processes (if any) along with proofs (tokens, which are generated using a random function) to the sanitizer. Proofs will be used for a later verification operation by proof checker. After receiving and storing the blacklist and proofs, the sanitizer 202 generates random keystrokes and waits for processes to listen to them.

Listing 1 below shows a sample code snippet in Java to simulate key-press events, using which random keystrokes can be generated. This way, once keystrokes are generated, the sanitizer waits for various processes to capture them.

Listing 1: Sample code to generate key strokes in Java

public class KeyStrokeGeneration {
public static void main(String[ ] args) throws AWTException {
Robot robot = new Robot( );
System.out.printIn(″About to generate the keystrokes ‘Hi′
programatically″);
robot.keyPress(KeyEvent.VK_H);
robot.keyPress(KeyEvent.VK_I);
}
}

Typically processes do operations such as saving the captured data to file, capturing screenshot of user's screen, and sending data across network, etc., after capturing key strokes. The probability of processes doing a combination of these processes is high if the process is a malicious process, since its primary goal is to steal data, which cannot be achieved without performing these operations. This way, the sanitizer can identify malicious processes, append them to blacklist or termed as the malicious list and update the cloud service 201 with the same, while alerting the user. Note that processes can use some stealth techniques to escape from sanitizer's blacklisting mechanism. To identify such rogue processes, we propose a second line of defense, which is the proof checker. Detailed description of how proof checker works is explained in the next section.

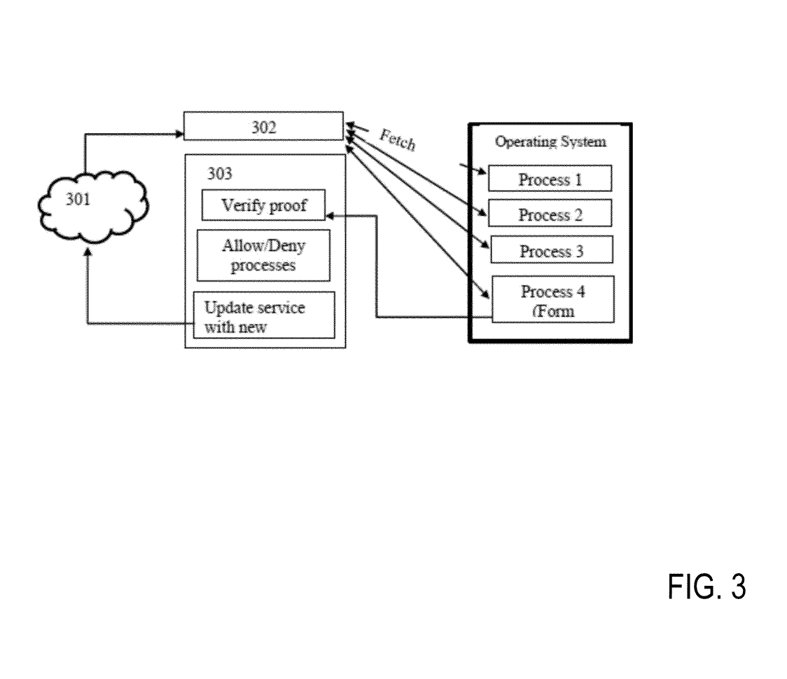

FIG. 3 disclose the activity of the proof checker 303.

The key idea of having of proof checker 303 is as follows—Whenever a process triggers a network call or a file write operation by way of example and not limitation, it has to prove that it has the necessary privileges to do so. The proof checker 303 plays the role of proof verification authority and allows a process to do the aforementioned operations only if they submit a valid proof. The proof may be as simple as a random number, which is sent by our cloud service to the sanitizer. By using techniques such as cryptographic key establishment protocols, a process can show its identity/attributes and get the proof from the sanitizer. Once it gets the proof, the proof checker verifies if it is the relevant proof and grants access only if the check passes.

As soon as a user opens a browser, the sanitizer gets invoked and it contacts the cloud service. The cloud service generates and sends proofs (tokens which are generated by a random function), to the sanitizer. (This step is analogous to generation of unique employee numbers by a central authority in a company and embedding the info on smart cards). Each of the processes displays their process Ids and other attributes (such as their capabilities in terms of which services they can invoke) to the sanitizer and fetch their corresponding proofs.

Before performing any sensitive operation such as network activity, file write operation etc., every process has to prove to the proof checker that it has the capability to do so. (This is analogous to an employee swiping in at turnstiles and entering the campus only after authentication). At the backend, the sanitizer and the proof checker will synchronize the proofs so that the proof checker can verify the same proof sent by sanitizer (This is analogous to the central authority synchronizing the authentication info to the turnstile machines at the backend). If a process fails in the proof checking phase, it will be denied access to the sensitive operation, the blacklist in the cloud service will be updated with the fake process and the end user will be alerted about the security breach (In the analogy, even if a person shows a fake ID card and try to impersonate a genuine person, the turnstile machines reject the person and inform the security team about the security breach). This way, the proof checker will restrict access to malicious processes.

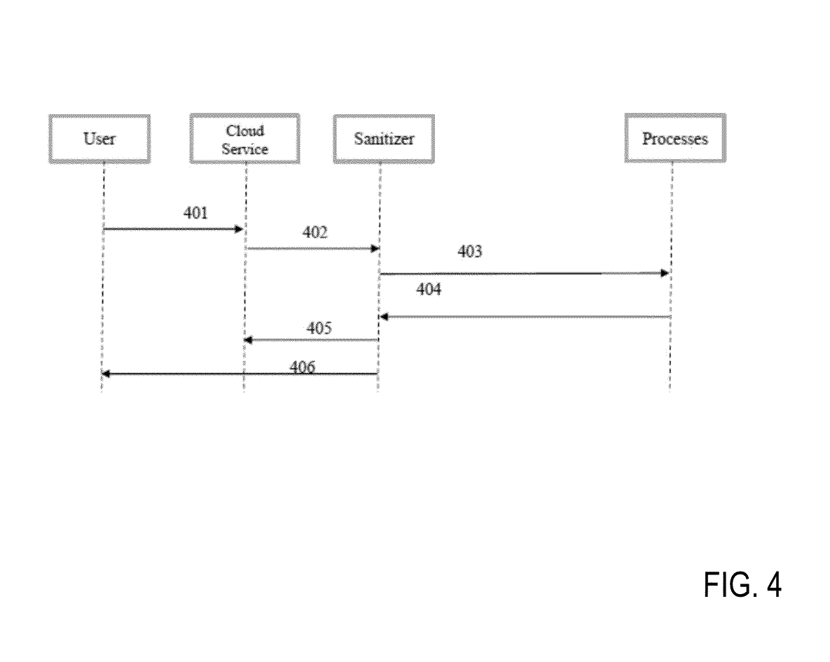

FIG. 4 discloses the work flow of the sanitizer.

At step 401 triggering of a cloud computing network by opening of a browser of a digital device. The browser is embedded with a plugin. The plugin has a sanitizer and a proof checker;

At step 402 as the browser is opened one or more proof is generated by the cloud computing network and sent to the sanitizer. Further the black listed process as termed as malicious processes that are already stored in the cloud computing network from before are sent to the sanitizer.

At step 403 the triggering of the sanitizer by opening of the browser of the digital device generates random sequence of keystrokes and generating of malicious list by the sanitizer by capturing the system processes that capture the randomly generated keystrokes and the system processes that perform malicious operations.

By way of example and not limitation, the malicious operations performed by the system processes comprises combination of one or more key logging operations or one or more network call operations or one or more screen capture operations or one or more file write operation.

At step 404 the sanitizer filters the malicious operations or the processes that do malicious or suspicious activities.

At step 405 the sanitizer updates the cloud computing network by the sanitizer with the generated malicious list.

The generation of malicious list by the sanitizer comprises capturing of the randomly generated keystrokes by the system processes to create one or more filtered list; where the intersection of the malicious operations with the filtered list generate one or more malicious list.

At step 406 the user is alerted of malicious operations performed by the system processes in the malicious list, where the malicious list is created by the sanitizer.

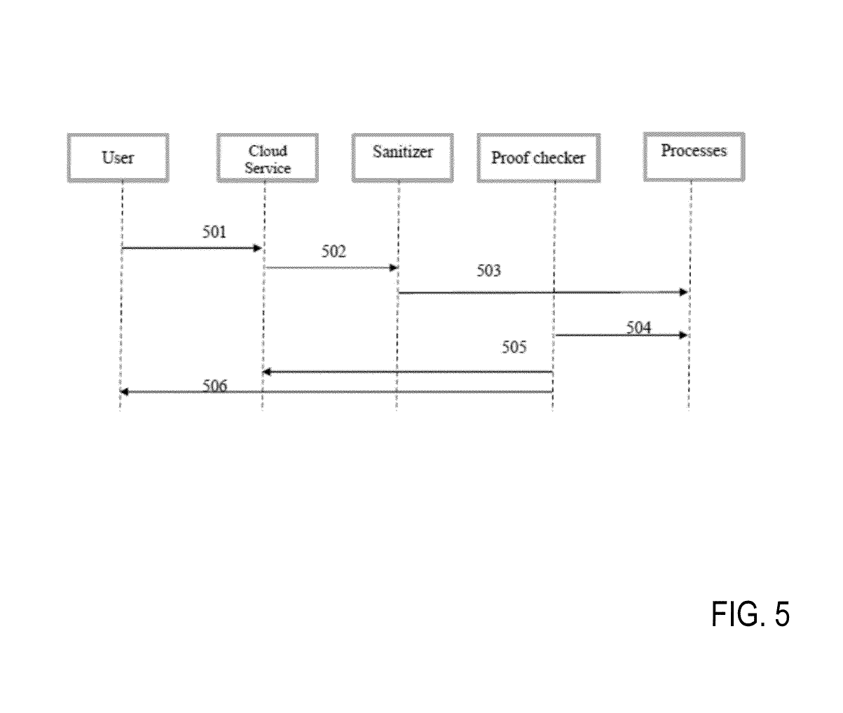

FIG. 5 the work flow of the proof checker.

At step 501 triggering of a cloud computing network by opening of a browser of a digital device. The browser is embedded with a plugin. The plugin has a sanitizer and a proof checker;

At step 502 as the browser is opened one or more proof is generated by the cloud computing network and sent to the sanitizer. Further the black listed process as termed as malicious processes that are already stored in the cloud computing network from before are sent to the sanitizer. The cloud computing network stores the proof. The proof can be any type of random number.

At step 503 retrieving of proof by each of the system processes, where the system processes show their identities or their attributes to the sanitizer to fetch their corresponding proofs from the sanitizer.

Further step 504 discloses verifying of the fetched proof of the system process by the proof checker and allowing the system processes with valid proof and restricting the rest of the system processes.

At step 505 updating the cloud computing network with the restricted system processes by the proof checker, where the restricted system processes are stored into the malicious list.

At step 506 the user is alerted of malicious operations performed by the system processes in the malicious list, where the malicious list is created by the proof checker.

According to one of the embodiments of the present disclosure there is provided a computer readable code stored on a non-transitory computer readable medium that when executed by a computing device, performs a method. The method comprises triggering of a cloud computing network by opening of a browser of one or more digital device, wherein embedding the browser with a plugin, wherein the plugin comprising a sanitizer and a proof checker.

Then generating of a proof by the cloud computing network and sending the generated proof to the sanitizer, trigger the sanitizer by opening of the browser of the digital device to generate random sequence of keystrokes, generate a malicious list by the sanitizer by capturing the system processes that capture the randomly generated keystrokes and the system processes that perform a malicious operation.

Further update the cloud computing network by the sanitizer with the generated malicious list and retrieving of proof by each of the system processes, wherein the system processes show their identities or their attributes to the sanitizer to fetch their corresponding proofs from the sanitizer.

Finally verify the fetched proof of the system process by the proof checker and allowing the system processes with valid proof and restricting the rest of the system processes; and updating the cloud computing network with the restricted system processes by the proof checker, wherein the restricted system processes are stored into the malicious list.

While this invention has been described in terms of several preferred embodiments, it is contemplated that alternatives, modifications, permutations and equivalents thereof will become apparent to those skilled in the art upon a reading of the specification and study of the drawings. It is therefore intended that the true spirit and scope of the present include all such alternatives, modifications, permutations and equivalents.

Further in view of the many possible embodiments to which the principle of out invention may be applied, we claim as our invention all such embodiments as may come within the scope and sprit of the following claims and equivalents thereto.

What is claimed is:

1. A method, the method comprising steps of:
triggering of at least one cloud computing network by opening of at least one browser of one or more digital device, wherein embedding the browser with a plugin, wherein the plugin comprising at least one sanitizer and at least one proof checker;
generating of at least one proof by the cloud computing network and sending the generated proof to the sanitizer;
triggering of the sanitizer by opening of the browser of the digital device to generate one or more random sequence of keystrokes;
generating at least one malicious list by the sanitizer by capturing the system processes that capture the randomly generated keystrokes and the system processes that perform at least one malicious operation;
updating the cloud computing network by the sanitizer with the generated malicious list;
retrieving of proof by each of the system processes, wherein the system processes show at least one of their identities or at least one of their attributes to the sanitizer to fetch their corresponding proofs from the sanitizer;
verifying of the fetched proof of the system process by the proof checker and allowing the system processes with valid proof and restricting the rest of the system processes; and
updating the cloud computing network with the restricted system processes by the proof checker, wherein the restricted system processes are stored into the malicious list.

2. The method of claim 1 wherein the cloud computing network stores at least one proof.

3. The method of claim 2 wherein the proof comprises at least one random number.

4. The method of claim 1 wherein the cloud computing stores at least one malicious list.

5. The method of claim 1 wherein the malicious operations performed by the system processes comprises combination of one or more key logging operations or one or more network call operations or one or more screen capture operations or one or more file write operation or the like.

6. The method of claim 5 wherein generating of at least one proof by the cloud computing network occurs when the browser with the embedded plugin is opened.

7. The method of claim 1 wherein generation of malicious list by the sanitizer comprises capturing of one or more randomly generated keystrokes by at least one system processes to create one or more filtered list; wherein the intersection of one or more malicious operations with the filtered list generate at least one malicious list.

8. The method of claim 1 further comprises alerting the user of malicious operations performed by the system processes in the malicious list as created by the sanitizer and the proof checker.

9. The method of claim 1 wherein notifying the user of the malicious list by the the sanitizer and the proof checker.

10. A system comprising:
at least one browser of one or more digital device embedded with a plugin, wherein the plugin comprising at least one sanitizer and at least one proof checker;
wherein the sanitizer operatively connected with the cloud computing network to receive at least one malicious list and at least one proof from the cloud computing network;
wherein the sanitizer generates random key strokes and captures at least one of the system processes that capture such generated key strokes; wherein the sanitizer creates one malicious list by capturing the system processes that capture the randomly generated keystrokes and the system processes that perform at least one malicious operations and the cloud computing network is updated with the malicious list by the sanitizer;
wherein the sanitizer receives at least one proof for each system processes, the system processes show at least one of their identities or at least one of their attributes to the sanitizer to fetch its corresponding proof from the sanitizer; and
wherein the proof checker operatively connected with the sanitizer to verify the fetched proof of the system process and allowing the system processes with valid proof and restricting the rest of the system processes.

11. The system of claim 10 wherein the cloud computing network is triggered when the browser is opened.

12. The system of claim 10 wherein the cloud computing network comprises at least one proof.

13. The system of claim 12 wherein the proof comprises at least one random number.

14. The system of claim 10 wherein the system processes that perform malicious operations comprises combination of one or more key logging operations or network call operations or screen capture operations or file write operation or the like.

15. The system of claim 10 wherein cloud computing network generates at least one proof when the system process performs at least one malicious operations.

16. The system of claim 10 wherein the sanitizer adapted to alert the user of malicious operation performed by the system processes in the malicious list as created by the sanitizer.

17. The system of claim 10 wherein the proof checker adapted to alert the user of malicious operation performed by the system processes in the malicious list as created by the proof checker.

18. A computer readable code stored on a non-transitory computer readable medium that when executed by a computing device, performs a method comprising
triggering of at least one cloud computing network by opening of at least one browser of one or more digital device, wherein embedding the browser with a plugin, wherein the plugin comprising at least one sanitizer and at least one proof checker;
generating of at least one proof by the cloud computing network and sending the generated proof to the sanitizer;
triggering of the sanitizer by opening of the browser of the digital device to generate one or more random sequence of keystrokes;
generating at least one malicious list by the sanitizer by capturing the system processes that capture the randomly generated keystrokes and the system processes that perform at least one malicious operation;
updating the cloud computing network by the sanitizer with the generated malicious list;
retrieving of proof by each of the system processes, wherein the system processes show at least one of their identities or at least one of their attributes to the sanitizer to fetch their corresponding proofs from the sanitizer;
verifying of the fetched proof of the system process by the proof checker and allowing the system processes with valid proof and restricting the rest of the system processes; and
updating the cloud computing network with the restricted system processes by the proof checker, wherein the restricted system processes are stored into the malicious list.
